(19) United States
(12) Patent Application Publication
(10) Pub. No.: US 2002/0032846 A1
(43) Pub. Date: Mar. 14, 2002

(54) Memory management apparatus and method

(76) Inventors: John Michael Doyle, Co. Kerry (IE); Sean Desmond O'Byrne, Dublin (IE); Stephen McQuillan, Belfast (IE)

Correspondence Address: Thomas C. Webster, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/814,671

(22) Filed: Mar. 21, 2001

Related U.S. Application Data
(60) Provisional application No. 60/191,310, filed on Mar. 21, 2000.

(51) Int. Cl. G06F 12/02

(52) U.S. Cl. 711/202

(57) ABSTRACT

A machine-readable medium is described having code stored thereon which defines an integrated circuit (IC), the IC comprising: a host processor to process data and perform address calculations associated with the data; and a peripheral address generation unit (“PAGU”) to offload specified types of the address calculations from the host processor.

### PRIORITY

This application claims the benefit of the filing date for U.S. Provisional Application No. 60/191,310, filed Mar. 21, 2000.

### BACKGROUND OF THE INVENTION

1. Field of the Invention

This invention relates generally to the field of memory management architecture and design. More particularly, the invention relates to an improved apparatus and method for address generation and associated DMA transfers.

2. Description of the Related Art

A Direct Memory Access (“DMA”) controller is a specialized circuit or a dedicated microprocessor which transfers data from one memory to another memory (or to/from a memory from/to a system component such as an audio card) without the supervision of the host processor. The host processor may be a general purpose CPU, an application-specific integrated circuit (“ASIC”), a digital signal processor, or any other type of data processing logic. Although the DMA controller may periodically consume cycles from the host processor (e.g., via an interrupt), data is transferred much faster than using the host processor for every byte of transfer. Moreover, offloading data transfers from the host processor in this manner allows the host processor to execute other tasks more efficiently.

In order to perform a DMA transfer, the DMA controller is provided with a source address from which the data will be transferred, a destination address to which the data will be transferred and an indication of the size/amount of data to be transferred. The DMA controller will then transfer the data from source to destination via a DMA “channel” comprised of a set of registers (e.g., for storing the source/destination addresses) and/or data buffers (e.g., for storing the underlying data). Address generation logic embedded within the host processor is typically used to calculate the source and destination addresses for the DMA transfers.

When large, contiguous blocks of data are transferred from source to destination, the address generation logic and DMA controller work relatively well. However, when small, non-contiguous blocks of data (i.e., not uniformly distributed throughout the memory space) are transferred, currently-available DMA controllers and address generation units do not perform efficiently. For example, when working with these types of data, the address generation unit must continually calculate new source and destination addresses and transfer these values to the DMA controller which, in turn, must perform each independent data transfer.

Accordingly, what is needed is a more efficient apparatus and method for memory management. What is also needed is an apparatus and method for calculating a series of addresses without consuming the host processor's core processing power. What is also needed is an apparatus and method for direct memory access which includes an efficient indirect addressing scheme.

### SUMMARY

A machine-readable medium is described having code stored thereon which defines an integrated circuit (IC), the IC comprising: a host processor to process data and perform address calculations associated with the data; and a peripheral address generation unit (“PAGU”) to offload specified types of the address calculations from the host processor.

### BRIEF DESCRIPTION OF THE DRAWINGS

A better understanding of the present invention can be obtained from the following detailed description in conjunction with the following drawings, in which:

FIG. 1 illustrates a memory management co-processor according to one embodiment of the invention.

FIG.2 illustrates a delay line having a base pointer and a plurality of tap address points.

FIG. 3 illustrates a peripheral address generation unit employed in one embodiment of the invention.

FIG. 4 illustrates a table indicating modulo-arithmetic operations according to one embodiment of the invention.

FIG. 5 illustrates an arithmetic logic unit (“ALU”) according to one embodiment of the invention.

FIG. 6 illustrates an apparatus and method for performing direct memory access (“DMA”) according to one embodiment of the invention.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the invention.

Embodiments of the present invention include various steps, which will be described below. The steps may be embodied in machine-executable instructions or, alternatively, these steps may be performed by specific hardware components that contain hardwired logic for performing the steps (e.g., an integrated circuit), or by any combination of programmed computer components and custom hardware components.

Elements of the present invention may also be provided as a machine-readable medium for storing machine-executable instructions or other types of code/data (e.g., VHDL code). The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing code/data. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

### Embodiments of the Memory

### Management Apparatus and Method

In one embodiment of the invention a Memory Management Co-Processor is provided to provide enhanced addressing and direct memory access (“DMA”) functions, thereby reducing the load on the host processor. The host processor may be a digital signal processor (“DSP”). However, it should be noted that the underlying principles of the invention may be implemented with virtually any type of host processor (e.g., a general purpose CPU, an application-specific integrated circuit (“ASIC”), . . . etc).

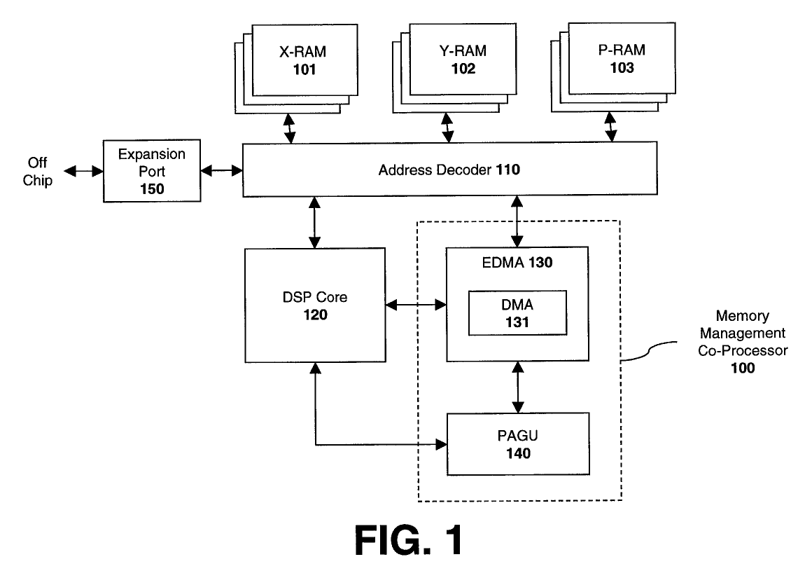

As illustrated in FIG. 1, one embodiment of the invention is comprised of enhanced DMA logic (“EDMA”) 131 for performing the various DMA functions described herein. In addition, in one embodiment, a dedicated peripheral address generation unit (“PAGU”) 140 is employed to efficiently calculate a series of addresses for indirect addressing into memory. The memory management co-processor is comprised of both the EDMA 130 and the PAGU 140. Although the DMA 131 is illustrated as a separate logical unit in FIG. 1, those of ordinary skill in the art will appreciate that a logic separation between the EDMA logic 130 and the “standard” DMA logic 131 is not necessary for complying with the underlying principles of the invention.

Other system components illustrated in FIG. 1 include a DSP core 120, an address decoder 110, system memory 101, 102, 103, and an expansion port 150. The address decoder 110 converts logical memory addresses (provided by various system components) into physical addresses for accessing data stored within the system memories 101-103. The expansion port 150 is for transmitting/receiving data from other chips and/or peripherals.

In one embodiment, the DSP core 120 “the system master” will configure both the EDMA 130 and PAGU 140 for the operation of choice. These units work in parallel with the functions being performed by the DSP core 120, releasing the core 120 to perform other functions (e.g., more algorithm-intensive functions) and thereby increasing the MIPs capability of the DSP core 120.

### PAGU Introduction

As mentioned briefly above, the PAGU 140 is capable of calculating a series of addresses which may then be used for indirect addressing into memory 101-103. This operation, once configured by the core processor 120, may operate in the background to generate the address list, thus freeing up the core 120 to perform other functions.

Indirect addressing of this type may be used to improve the processing efficiency of various multimedia signal processing applications. For example, in one embodiment the memory management scheme described herein may be used for generating audio effects such as Reverb, Chorus and Flange. These effects are often processed in the time domain and typically require circular delay lines. The size and number of the delay lines depends on the complexity of the effect.

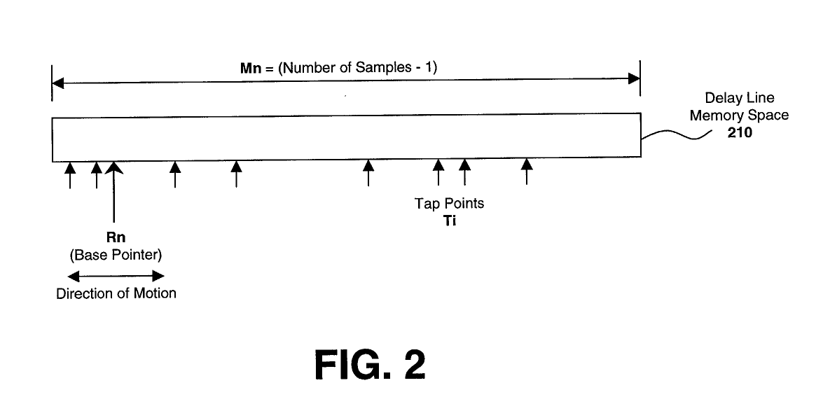

Maintaining a delay line requires reading from various “tap” address points in the line and continually updating new address points in the line as they become available. Because of the sheer number of tap point calculations this process can consume a considerable amount of the core processing capability. An exemplary delay line 210 is illustrated in FIG. 2. It is simply a block of memory 210 into which the data samples (e.g., multimedia samples) are written. It will have a specific length which indicates the number of samples it can hold (Mn) and a number of tap points (Ti) which are normally randomly spaced along the delay line in order to prevent any periodicity in the sample points. It also includes a base pointer (Rn) from which all the tap points will have a relative location (e.g., the sample is identified by adding the tap point offset to the base pointer address Rn). The delay line 210 is maintained/propagated by moving this base pointer along the line.

Samples of data from the various tap points Ti are collected for processing by the DSP core 120. As mentioned above, in one embodiment of the invention, this data collection is performed in the background and the DSP core 120 is interrupted only after a complete set of samples have been gathered. In one embodiment, the EDMA logic described herein is used to move the data from the delay line based on the tap addresses calculated by the PAGU.

### Functional Description of One Embodiment

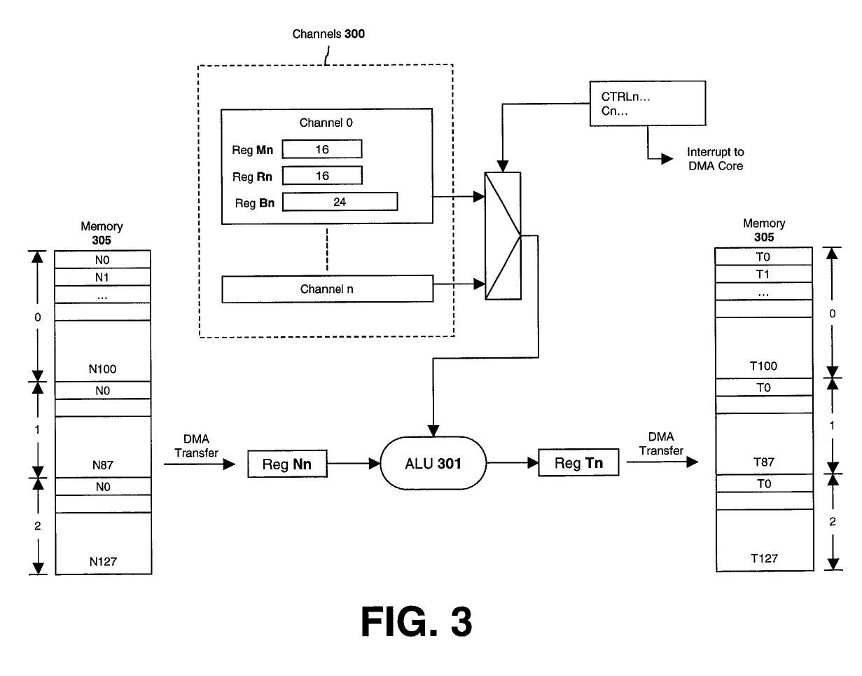

As illustrated in FIG. 3, in one embodiment, the PAGU 140 is comprised of several individual addressing channels 300, with each channel capable of providing memory management support for an individual delay line. In one particular embodiment, six channels (channels 0-5) are provided. However, various numbers of channels may be employed while still complying with the underlying principles of the invention. In one embodiment, only a single channel is active at any given time. The DSP core 120 configures each channel before it can calculate a set of indirect addresses into the delay line memory segment 210. The following registers may be configured an a per channel basis:

(Bn) Base Address Register (24 bits). This specifies the fixed starting address in memory of the Delay line segment.

(Mn) Modulo address register (16 bit). This register specifies the length of the delay line and is equal to the number of samples-1. It is limited to 16 bits giving a maximum number of samples =65536+1.

(Rn) Pointer Address Register (16 Bits). This is the master pointer into the delay line. It can have a value in the range of 0 to Mn. This has a value which is an offset from the Bn.

(Cn) Tap counter (7 bits). This indicates the number of Taps in the delay line allowing from 0 to 127 taps.

(CTRLn) Channel control register (4 bits). Used to control automatic updating of the Pointer Address Register (Rn), interrupt configuration.

In one embodiment, the DSP core 120 calculates the offset position of the tap addresses Ti, which are then stored in internal memory 305. The tap addresses may be stored in contiguous memory locations. The number of these offset values is equal to the number of taps programmed in the tap counter register Cn. For multiple delay lines, all the tap point offsets may be stored in one contiguous block of memory.

In one embodiment of the invention, the PAGU 140 will calculate the actual address for each tap point in memory using the following formula:

Ti=Bn+([Rn+Ni] mod Mn),

where i is the number of tap points within the delay line memory 210 in the range 0 to Cn, and n is the channel number.

An arithmetic logic unit 301 (“ALU”) (described in greater detail below) configured within the PAGU 140 includes an input register Nn which is loaded with the offset value for each successive tap address calculation. As indicated in FIG. 3, in one embodiment, one channel of the EDMA 130 transfers the value of the offset from internal memory to the PAGU 140. The result of the address calculation is then stored in a register Tn (a 24-bit register in one embodiment). One of the EDMA channels 300 is then used to move each successive tap address to an internal memory table (i.e., stored in memory 305).

The value in Cn is decremented for each tap calculation in order to determine when the complete set of taps for the delay have been calculated. This value may be used to trigger an interrupt to the DSP core 120 to allow it to configure the next EDMA channel 300 and/or to possibly trigger the next channel to perform address calculations (e.g., when Cn equals zero, this indicates that the current set of tap address calculations are complete).

At the end of each channels' calculations the value in Rn may be updated with [+1, 0, −1 ] based on the CTRLn. The following description with respect to FIGS. 3 through 5, illustrates this operation.

### ALU Functionality of One Embodiment

For each tap address, which is calculated relative to the base address pointer Rn, the resulting address must lie within the bounds of the delay line 210. As the value in Rn moves through the range of the delay line addresses, the tap addresses may wrap around within the buffer. Accordingly, in one embodiment, Modulo Arithmetic is performed to calculate the offsets relative to the pointer Rn and to calculate updates to the pointer Rn itself. The actual address in memory may be calculated by adding these offsets to the Delay Line Base Address (Bn).

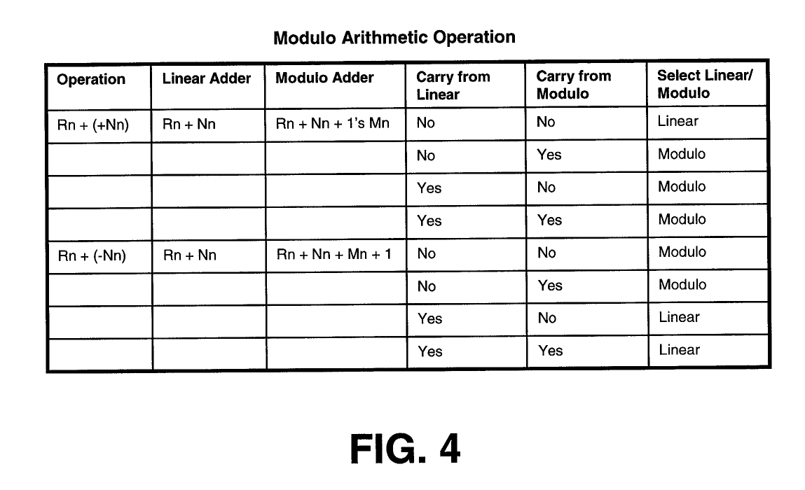

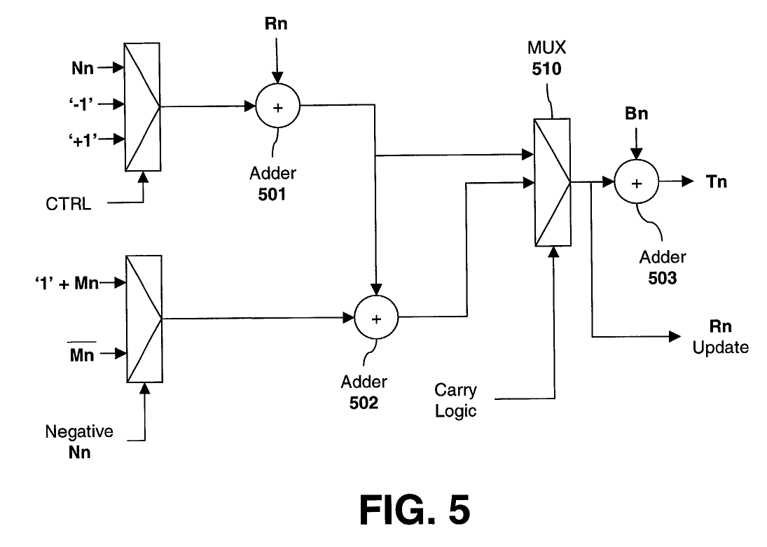

As illustrated in FIG. 5, two adders 501-502 may be used to implement the Modulo arithmetic. One adder 501 simply adds Rn and Nn for either positive or negative Nn. The second adder 502 sums this result with either the 1's complement of Mn (for positive Nn) or Mn+1 (for negative Nn). Depending on the Carry generated form these adders the result of the appropriate adder is selected (i.e., via multiplexer 510). These functions are outlined in the table illustrated in FIG. 4.

### One Embodiment of EDMA Operation

In addition to the features contained in the DSP DMA controller described in DSP DMA Controller, Revision 1.1, 14 March 2001 (hereinafter “DSP DMA”) from Parthus Technologies (the assignee of the present application) the following features shall be supported by the Enhanced DMA Controller (“EDMA”):

For backward compatibility, a mode select bit to select DMA or EDMA functionality may be provided. Setting the mode bit shall enable the EDMA functionality. The EDMA shall support the functionality of the DMA.

EDMA shall have read/write access to all DMA registers to enable auto-programming.

Each channel of the EDMA shall have the capability of being triggered from various sources including, for example, a software trigger and one of any of the other 32 trigger sources set forth in DSP DMA.

The EDMA shall have the ability to generate a trigger and an interrupt on completion of a word, line or block transfer.

The following diagram illustrates EDMA 130 operation according to one embodiment of the invention. It should be noted, however, that this represents only one of the many potential uses of the EDMA 130 functionality.

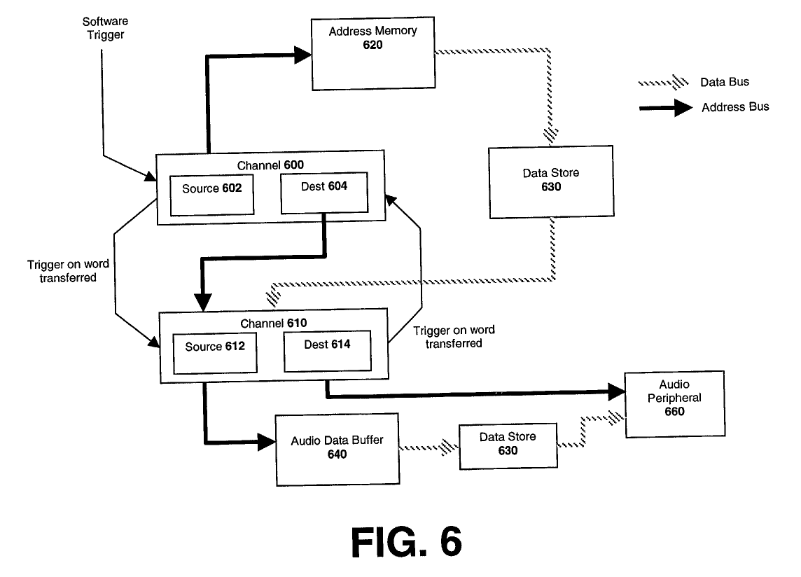

EDMA channel 600 in this example is comprised of a source address register 602 programmed with a source address for the DMA transfer and a count (not shown) indicating the number of transfers to be performed. The contents of the destination address register 604 point to the source address register 612 of EDMA channel 610. As indicated in FIG. 6, channel 600 is capable of being triggered by software and/or by a trigger from channel 610 (e.g., when a word transfer is complete). Channel 610 in this embodiment is programmed with a destination address (e.g. an audio peripheral) stored in destination address register 614 and the same count as that of channel 600. Channel 610 is triggered by channel 600 (e.g., when a word transfer is complete).

As indicated in FIG. 6, channel 600 may be triggered by software. The source address 602 in the illustrated example points to a memory 620 storing a table of pointers which point to audio samples in an audio buffer 640. The source slot executes and the data read from the memory at the address pointed to by the source address register 602 is temporarily stored in the EDMA data store register 630. The contents of the data store 630 are then transferred to the source register 612 of channel 610 (e.g., as identified by the destination address stored in destination register 604). On completion of this transfer, channel 600 generates a trigger which is received by channel 610.

Channel 610 activates and executes the source slot 612 addressing the audio data buffer. The audio data sample read is stored in the EDMA data store register 630. During the destination slot of channel 610, the contents of the data store are transferred to the destination address stored in the destination address register 614 (e.g. an audio peripheral). On completion of this transfer, channel 610 generates a trigger which is received by channel 600 causing channel 600 to initiate another transfer. The sequence terminates when the required number of transfers are complete.

The foregoing example assumes no other channels are active. If other channels are active then the channels may need to arbitrate to gain access to the EDMA buses.

Numerous advantages of the apparatus and method described herein will be readily apparent to one of ordinary skill in the art. For example, the described memory management co-processor provides for indirect addressing in a DMA controller. Prior DMA controllers were well suited to transferring one contiguous block of memory to another contiguous memory space. They were also well suited to transferring data that is uniformly distributed from one memory space to another. In various circumstances, however, (e.g., for signal processing applications such as reverb) the addresses/data (e.g., “taps” in a delay line) are not uniformly distributed in memory. Hence, when transferring data using prior DMA controllers, a block size equal to one would typically be used. By supporting indirect addressing in the EDMA, non-uniformly distributed data in memory may be efficiently transferred from one space to another using a block size transfer of size ‘n.’ Accordingly, the DMA controller need not be reprogrammed for these types of operations, resulting in a significant increase in MIPs over a standard DSP architecture. In addition, the EDMA controller described herein may perform indirect addressing in the background (i.e., without tying up the DSP core).

Additionally, the peripheral address generation unit provides a separate source for address generation, thereby reducing the load on the address generation unit of the DSP core. Accordingly, the address registers within the DSP address generation unit are free to be used in another applications, further increasing the MIPS available in the DSP.

Moreover, in prior DSP systems, DSP programmers needed to store the values of the address generation registers in memory when a new portion of an algorithm was ready to be executed. This meant that a significant amount of MIPS were wasted in storing and restoring the address as needed through interrupt service routines. The PAGU described herein reduces the need for this type of storing/restoring.

It is important to note that the apparatus and method described herein may be implemented in environments other than a physical integrated circuit (“IC”). For example, the circuitry may be incorporated into a format or machine-readable medium for use within a software tool for designing a semiconductor IC. Examples of such formats and/or media include computer readable media having a VHSIC Hardware Description Language (“VHDL”) description, a Register Transfer Level (“RTL”) netlist, and/or a GDSII description with suitable information corresponding to the described apparatus and method.

Throughout the foregoing description, for the purpose of explanation, numerous specific details were set forth in order to provide a thorough understanding of the invention. It will be apparent, however, to one skilled in the art that the invention may be practiced without some of these specific details. For example, while the embodiments described above employ registers of specific sizes (e.g., 16 bits for Mn, 24 bits for Bn, . . . etc), the underlying principles of the invention may be performed using registers of virtually any size.

Similarly, while the embodiments illustrated and described above operate using a host processor of a DSP core, the principles of the invention may be implemented in conjunction with virtually any type of processor (e.g., a general purpose processor, an ASIC, . . . etc). Accordingly, the scope and spirit of the invention should be judged in terms of the claims which follow.

What is claimed is:

1. A machine-readable medium having code stored thereon which defines an integrated circuit (IC), said IC comprising:
a host processor to process data and perform address calculations associated with said data; and
a peripheral address generation unit (“PAGU”) to offload specified types of address calculations from said host processor.

2. The machine-readable medium as in claim 1 wherein said host processor comprises a digital signal processor (“DSP”) core.

3. The machine-readable medium as in claim 1 wherein said specified types of address calculations comprise address calculations in which addressable data are non-uniformly distributed throughout memory.

4. The machine-readable medium as in claim 1 wherein said specified types of address calculations comprise calculations of address taps on a delay line.

5. The machine-readable medium as in claim 1 wherein said specified types of address calculations are address calculations associated with processing multimedia content.

6. The machine-readable medium as in claim 1 wherein said PAGU comprises:
a plurality of channels for storing address offsets used for said specified types of address calculations; and
an arithmetic logic unit (“ALU”) for performing said specified types of address calculations.

7. The machine-readable medium as in claim 6 wherein said ALU includes modulo arithmetic logic for performing modulo arithmetic.

8. An machine-readable medium as in claim 1 wherein said IC further comprises:
an enhanced direct memory access (“EDMA”) unit to perform successive transfers of data identified by addresses calculated using said specified types of address calculations.

9. The machine-readable medium as in claim 8 wherein said EDMA unit is configured to operate in parallel with one or more standard DMA units.

10. The machine-readable medium as in claim 8 wherein said EDMA unit is comprised of a plurality of EDMA channels, each EDMA channel having a source address register and a destination address register,
wherein an address stored in a destination register of a first one of said EDMA channels points to a source register of a second one of said EDMA channels.

11. The machine-readable medium as in claim 10 wherein an address stored in a source register of said first one of said EDMA channels points to a memory wherein a multimedia data sample is stored and wherein an address stored in said source register of said second one of said EDMA channels points to a multimedia data buffer.

12. The machine readable medium of claim 1 wherein said code defining an IC is VHDL code.

13. The machine readable medium of claim 1 wherein said code defining an IC is Register Transfer Level (“RTL”) netlist code.

14. The machine readable medium of claim 1 wherein said code defining an IC is GDSII code.

15. An apparatus comprising:
a host processor to process data and perform address calculations associated with said data; and
a peripheral address generation unit (“PAGU”) to offload specified types of address calculations from said host processor.

16. The apparatus as in claim 15 wherein said host processor comprises a digital signal processor (“DSP”) core.

17. The apparatus as in claim 15 wherein said specified types of address calculations comprise address calculations in which addressable data are non-uniformly distributed throughout memory.

18. The apparatus as in claim 15 wherein said specified types of address calculations comprise calculations of address taps on a delay line.

19. The apparatus as in claim 15 wherein said specified types of address calculations are address calculations associated with processing multimedia content.

20. The apparatus as in claim 15 wherein said PAGU comprises:
a plurality of channels for storing address offsets used for said specified types of address calculations; and
an arithmetic logic unit (“ALU”) for performing said specified types of address calculations.

21. The apparatus as in claim 20 wherein said ALU includes modulo arithmetic logic for performing modulo arithmetic.

22. An apparatus as in claim 15 wherein said IC further comprises:
an enhanced direct memory access (“EDMA”) unit to perform successive transfers of data identified by addresses calculated using said specified types of address calculations.

23. The apparatus as in claim 22 wherein said EDMA unit is configured to operate in parallel with one or more standard DMA units.

24. The apparatus as in claim 22 wherein said EDMA unit is comprised of a plurality of EDMA channels, each EDMA channel having a source address register and a destination address register,
wherein an address stored in a destination register of a first one of said EDMA channels points to a source register of a second one of said EDMA channels.

25. The apparatus as in claim 24 wherein an address stored in a source register of said first one of said EDMA channels points to a memory wherein a multimedia data sample is stored and wherein an address stored in said source register of said second one of said EDMA channels points to a multimedia data buffer.

26. A processor-implemented method comprising:
receiving an instruction requiring calculation of a series of addresses;
determining whether said series of addresses are associated with a particular type of data processing operation; and
calculating said series of addresses with a peripheral address generation unit (“PAGU”) if said series of addresses are associated with said particular type of data processing operation.

27. The method as in claim 26 wherein said particular type of data processing operation comprises reading data samples from a delay line, said data samples being identified by said series of addresses.

28. The method as in claim 26 further comprising:
calculating said series of addresses with a DSP core if said series of addresses are not associated with said particular type of data processing operation.

29. The method as in claim 26 further comprising:
transferring data identified by said series of addresses from a first memory space to a second memory space.

30. The method as in claim 26 further comprising:
transferring data identified by said series of addresses from a first memory space to a peripheral.

31. The method as in claim 26 wherein said data identified by said series of addresses comprise samples of audio data and said peripheral is an audio peripheral.

32. The method as in claim 26 further comprising:
transferring data identified by said series of addresses from a first memory space to a second memory space with an enhanced DMA (“EDMA”) unit.

33. The method as in claim 32 wherein transferring said data with said EDMA unit comprises:
transferring said data from a memory to an EDMA channel data store;
transferring said data from said EDMA channel data store to a peripheral.

34. The method as in claim 33 wherein said data is audio data and said peripheral is an audio peripheral.
